(19) United States
(12) Patent Application Publication
(10) Pub. No.: US 2023/0078722 A1
(43) Pub. Date: Mar. 16, 2023

(54) POLYPROPYLENE RESIN COMPOSITION, METHOD FOR PRODUCING POLYPROPYLENE RESIN COMPOSITION, AND MOLDED BODY

(71) Applicant: UBE MATERIAL INDUSTRIES, LTD., Ube-shi, Yamaguchi (JP)

(72) Inventors: Toru Inagaki, Ube-shi (JP); Yuzo Kato, Ube-shi (JP)

(73) Assignee: UBE MATERIAL INDUSTRIES, LTD., Ube-shi, Yamaguchi (JP)

(21) Appl. No.: 17/913,555

(22) PCT Filed: Mar. 1, 2021
(86) PCT No.: PCT/JP2021/007755

§ 371 Date: Sep. 22, 2022

(30) Foreign Application Priority Data
Mar. 30, 2020 (JP) 2020-059404

(51) Int. Cl. C08F 10/06; C08K 3/30; C08K 5/098; C08K 7/08; C08F 222/06

(52) U.S. Cl. CPC C08F 10/06; C08K 3/30; C08K 5/098; C08K 7/08; C08F 222/06; C08K 2003/3063; C08K 2201/003

(57) ABSTRACT

A polypropylene resin composition according to the present invention contains 1 to 41 parts by mass of fibrous basic magnesium sulfate, 50 to 98 parts by mass of a propylene polymer, 0.02 to 1.6 parts by mass of a lubricant, and less than 0.5 times the amount of the basic magnesium sulfate and 0.1 to 20 parts by mass of an acid-modified elastomer.

### TECHNICAL FIELD

The present invention relates to a polypropylene resin composition, method for producing the polypropylene resin composition, and a molded body.

### BACKGROUND ART

Basic magnesium sulfate is widely used as a filler for a resin such as a polypropylene resin. As basic magnesium sulfate, fibrous basic magnesium sulfate in which acid resistance is enhanced by, for example, treating with two types of surfactants that are anionic and cationic has been proposed (see, for example, Patent Literature 1). It is described that a resin composition containing this fibrous basic magnesium sulfate can suppress generation of blisters.

Basic magnesium sulfate powder whose surface is coated with an inorganic phosphorus compound has also been proposed (see, for example, Patent Literature 2). This basic magnesium sulfate powder maintains original solubility in vivo, whereby biological safety is secured. In addition, when the basic magnesium sulfate is blended with a resin, a resin composition that suppresses generation of blisters and has an improved thermal degradation properties is obtained. It is described that a molded body of this resin composition is excellent in impact-resistance strength.

Furthermore, a propylene-based resin composition containing a propylene polymer, a modified olefin polymer, a non-fibrous inorganic filler, and an elastomer together with basic magnesium sulfate as a fibrous inorganic filler has been proposed (see, for example, Patent Literature 3). It is described that, by using this resin composition, a molded body having an excellent balance of appearance, an excellent balance of rigidity and impact resistance, and an excellent balance of impact resistance and heat resistance is obtained.

### CITATION LIST

### Patent Literature

Patent Literature 1: WO 2016/186152 A

Patent Literature 2: JP 6612481 B

Patent Literature 3: JP 2006-56971 A

### SUMMARY OF INVENTION

### Technical Problem

As described above, basic magnesium sulfate is used as a filler for improving the physical properties such as FM (flexural modulus) and impact strength of the polypropylene resin, and the resin composition is used for members of automobiles and the like. In particular, when the resin composition is used for exterior materials such as a bumper that is exposed to rainwater, it is required to suppress generation of blisters so as not to impair the coating appearance as well as to have sufficient mechanical properties.

An object of the present invention is to provide a polypropylene resin composition that gives a molded body with suppressed generation of blisters and sufficient mechanical properties, and a method for producing the polypropylene resin composition. Another object of the invention is to provide a molded body in which generation of blisters is suppressed as much as possible and that has sufficient mechanical properties.

### Solution to Problem

The polypropylene resin composition according to the present invention contains 1 to 41 parts by mass of fibrous basic magnesium sulfate, 50 to 98 parts by mass of a propylene polymer, 0.02 to 1.6 parts by mass of a lubricant, and less than 0.5 times the amount of the basic magnesium sulfate and 0.1 to 20 parts by mass of an acid-modified elastomer.

The method for producing the polypropylene resin composition according to the present invention includes mixing 1 to 41 parts by mass of fibrous basic magnesium sulfate, 50 to 98 parts by mass of a propylene polymer, 0.02 to 1.6 parts by mass of a lubricant, and less than 0.5 times the amount of the basic magnesium sulfate and 0.1 to 20 parts by mass of an acid-modified elastomer, and then melt-kneading the mixture.

The molded body according to the present invention is a molded product of the polypropylene resin composition described above.

### Advantageous Effects of Invention

According to the present invention, it is possible to provide a polypropylene resin composition that gives a molded body with suppressed generation of blisters and sufficient mechanical properties, and a method for producing the polypropylene resin composition. According to the present invention, it is also possible to provide a molded body in which generation of blisters is suppressed and that has sufficient mechanical properties.

### DESCRIPTION OF EMBODIMENTS

The present inventors have made intensive studies and have thereby found that, by adding a predetermined amount of an acid-modified elastomer to a polypropylene resin composition containing fibrous basic magnesium sulfate, a propylene polymer, and a lubricant, generation of blisters in a resulting molded body can be suppressed, and the mechanical properties are also improved.

Hereinafter, embodiments of the present invention will be described in detail.

<Basic Magnesium Sulfate>

Basic magnesium sulfate is represented by MgSO₄.5Mg(OH)₂.3H₂O, and can be obtained by, for example, hydrothermal synthesis using magnesium sulfate and an alkaline substance such as sodium hydroxide, magnesium hydroxide, magnesium oxide, or calcium hydroxide as raw materials. As the basic magnesium sulfate, either fibrous basic magnesium sulfate or flabellate basic magnesium sulfate may be used, but fibrous basic magnesium sulfate is particularly preferable.

Fibers of fibrous basic magnesium sulfate have an average fiber length in the range of generally 2 to 100 μm and preferably 5 to 50 μm, and an average fiber diameter in the range of generally 0.1 to 2.0 μm and preferably 0.1 to 1.0 μm. The fibers of fibrous basic magnesium sulfate have an average aspect ratio (average fiber length/average fiber diameter) of generally 2 or more, preferably 3 to 1000, more preferably 3 to 100, and particularly preferably 5 to 50. Note that, the average fiber length and the average fiber diameter of fibers of fibrous basic magnesium sulfate can be calculated from the number average values of the fiber length and the fiber diameter respectively, which are measured by image analysis from images magnified with a scanning electron microscope (SEM).

The flabellate basic magnesium sulfate is particles in which multiple fibers of fibrous basic magnesium sulfate are partially joined to each other and connected into a flabellate shape, and the particles have, for example, an average particle length of 2 to 100 μm, an average particle width of 1 to 40 μm, and an average aspect ratio of about 1 to 100. Here, the average particle length refers to the dimension in the longitudinal axis of the particle, and the average particle width refers to the maximum dimension in the lateral axis of the particle. The longitudinal axis of the particle is an axis in which the particle length is maximized, and the lateral axis of the particle is an axis orthogonal to the longitudinal axis. The average aspect ratio is a ratio of an average particle length/average particle diameter.

The fibers of fibrous basic magnesium sulfate constituting a particle of flabellate basic magnesium sulfate each have an average fiber length of 2 to 100 μm, an average fiber diameter of 0.1 to 5 μm, and an average aspect ratio of 1 to 1000. Multiple fibers of fibrous basic magnesium sulfate are, for example, bundled at one ends and spread at the other ends. Multiple fibers of fibrous basic magnesium sulfate may also be bundled at arbitrary positions in the longitudinal axes and spread at both ends. Such flabellate basic magnesium sulfate can be produced and identified in accordance with methods described in, for example, JP H4-36092 B, JP H6-99147 B, and the like.

In addition, the flabellate basic magnesium sulfate is not necessarily in a state in which individual fiber of fibrous basic magnesium sulfate is identified, and may be in a state in which some fibers of fibrous basic magnesium sulfate are joined to each other along the longitudinal axes. When it is confirmed that fibers of fibrous basic magnesium sulfate having the shape as described above and further having an average fiber length, an average fiber diameter, and an average aspect ratio in predetermined ranges are contained, the fibrous basic magnesium sulfate can be regarded as flabellate basic magnesium sulfate used in the present invention.

The amount of the basic magnesium sulfate to be blended is 1 to 41 parts by mass. The amount of the basic magnesium sulfate is preferably 2 to 30 parts by mass, and more preferably 3 to 20 parts by mass.

<Propylene Polymer>

For the propylene polymer, a propylene homopolymer or a propylene copolymer can be used. A propylene block copolymer is more desirable as the propylene polymer from the viewpoint of high impact-resistance strength.

The amount of the propylene polymer to be blended is 50 to 98 parts by mass. The amount of the propylene polymer is preferably 50 to 90 parts by mass, and more preferably 55 to 85 parts by mass.

<Lubricant>

The lubricant can be selected from fatty acids and fatty acid metal salts. The fatty acid is preferably a saturated fatty acid, and examples thereof include stearic acid. Examples of the fatty acid metal salt include magnesium stearate, calcium stearate, and aluminum stearate.

The amount of the lubricant to be blended is 0.02 to 1.6 parts by mass. The amount of the lubricant is preferably 0.04 to 1.2 parts by mass, and more preferably 0.06 to 0.8 parts by mass.

<Acid-Modified Elastomer>

The acid-modified elastomer is preferably a maleic anhydride-modified elastomer, and specific examples thereof include maleic anhydride-modified styrene-ethylene-butylene-styrene (SEBS). The ratio (S/EB) of styrene (S) to ethylene-butylene (EB) in SEBS is preferably about 10/90 to 50/50, and more preferably about 20/80 to 40/60.

The acid-modified elastomer preferably has a grafting percentage of about 1.0 to 10.0%. The grafting percentage can be calculated by the following procedure. First, the acid-modified elastomer is dissolved in xylene, and then reprecipitated in acetone to remove impurities. Thereafter, the graft maleic anhydride moiety is methyl-esterified, and ¹H-NMR measurement is performed after the methyl esterification. Using the ¹-H peak area of the obtained spectrum, the grafting percentage can be determined. The grafting percentage is more preferably about 1.0 to 5.0%.

The amount of the acid-modified elastomer to be blended is less than 0.5 times the amount of the basic magnesium sulfate and 0.1 to 20 parts by mass. The resin composition containing a predetermined amount of the acid-modified elastomer is used, whereby a molded body in which generation of blisters is suppressed and that has excellent flexural modulus and Charpy impact strength is obtained. The amount of the acid-modified elastomer is preferably about 0.05 to 0.5 times, more preferably about 0.1 to 0.3 times the amount of the basic magnesium sulfate. The amount of the acid-modified elastomer is also preferably 0.1 to 15 parts by mass, and more preferably 0.2 to 10 parts by mass.

In addition to the above components, the polypropylene resin composition of the present invention may contain 40 parts by mass or less of an elastomer. Examples of the elastomer include ethylene-α-olefin copolymeric elastomers and styrenic elastomers. The elastomers may be used singly or in combination of two or more thereof.

Specific examples of the ethylene-α-olefin copolymeric elastomers include an ethylene-propylene copolymeric elastomer (EPR), an ethylene-1-butylene copolymeric elastomer (EBR), an ethylene-1-octene copolymeric elastomer (EOR), an ethylene-propylene-non-conjugated diene copolymeric elastomer (EPDM), an ethylene-propylene-1-butylene copolymeric elastomer (EPBR), an ethylene-1-butylene-non-conjugated diene copolymeric elastomer (EBDM), and an ethylene-propylene-1-butylene-non-conjugated diene copolymeric elastomer (EPBDM).

Specific examples of the styrenic elastomers include block copolymers such as a styrene-butadiene block copolymeric elastomer (SBR), a styrene-butadiene-styrene block copolymeric elastomer (SBS), a styrene-isoprene-styrene block copolymeric elastomer (SIS), a styrene-ethylene-butylene-styrene block copolymeric elastomer (SEBS), and a styrene-ethylene-propylene-styrene block copolymeric elastomer (SEPS), and block copolymers obtained by hydrogenating these elastomers.

The amount of the elastomer to be blended is preferably 5 to 35 parts by mass, and more preferably 10 to 30 parts by mass. The elastomer is contained, whereby the impact-resistance strength is further enhanced, and the effect of the present invention is not impaired. An olefinic elastomer may be used as the elastomer.

Furthermore, the polypropylene resin composition of the present invention may contain a non-fibrous filler. Examples of the non-fibrous filler include talc, mica, calcium carbonate, barium sulfate, magnesium carbonate, clay, alumina, silica, calcium sulfate, silica sand, carbon black, titanium oxide, magnesium hydroxide, zeolite, molybdenum, diatomite, sericite, shirasu, calcium hydroxide, calcium sulfite, sodium sulfate, bentonite, and graphite, and talc is particularly preferable. The non-fibrous filler is contained in an amount of up to 40 parts by mass, whereby it is possible to obtain a molded body having more excellent impact strength, gloss, appearance, and the like.

Furthermore, other components can be blended in the polypropylene resin composition of the present invention as long as the effects of the invention are not impaired. Examples of other components include an antioxidant, an ultraviolet absorber, a pigment, an antistatic agent, a copper inhibitor, a flame retardant, a neutralizing agent, a foaming agent, a plasticizer, a nucleating agent, an anti-bubble agent, and a crosslinking agent.

<Method for Producing Polypropylene Resin Composition>

For production of the polypropylene resin composition of the present invention, first, the basic magnesium sulfate, propylene polymer, lubricant, and acid-modified elastomer are mixed in predetermined amounts. The amount of each component to be blended is 1 to 41 parts by mass for the basic magnesium sulfate, 50 to 98 parts by mass for the propylene polymer, and 0.02 to 1.6 parts by mass for the lubricant. The amount of the acid-modified elastomer to be blended is less than 0.5 times the amount of the basic magnesium sulfate and 0.1 to 20 parts by mass. For the mixing, a tumbler, a blender, a Henschel mixer, or the like can be used.

The obtained mixture is melt-kneaded at 180 to 250° C. using a twin-screw kneader or the like, and thus, the polypropylene resin composition of the present invention is obtained.

<Molded Body>

The molded body of the present invention can be produced by molding the polypropylene resin composition of the invention. For the molding, a molding machine can be used, such as a roll molding machine (such as a calender molding machine), a vacuum molding machine, an extrusion molding machine, an injection molding machine, a blow molding machine, or a press molding machine.

As described above, since the resin composition of the present invention contains the acid-modified elastomer in a predetermined amount, a molded body in which generation of blisters is suppressed and that has excellent flexural modulus and Charpy impact strength can be obtained.

### EXAMPLES

Specific examples of the present invention will be described below, but these do not limit the invention.

The raw materials used are summarized below.

<Raw materials>

Fibrous basic magnesium sulfate (A-1): MOS-HIGE A-1, manufactured by Ube Material Industries, Ltd., an average major diameter of 15 μm, an average minor diameter of 0.5 μm

Propylene polymer (B): polypropylene block polymer, Prime Polypro J708UG, manufactured by Prime Polymer Co., Ltd.

Polyolefin elastomer (C): ethylene-1-octene copolymer rubber, ENGAGE7270, manufactured by Dow Chemical Company

Fatty acid metal salt (E): magnesium stearate

Acid-modified elastomer (F-1):

Maleic anhydride-modified SEBS (styrene-ethylene-butylene-styrene), Tuftec M1913, manufactured by Asahi Kasei Corp., styrene/ethylene-butylene=30/70, a grafting percentage of 1.63%

Acid-modified elastomer (F-2):

Maleic anhydride-modified SEBS (styrene-ethylene-butylene-styrene), Tuftec M1943, manufactured by Asahi Kasei Corp., styrene/ethylene-butylene=20/80, a grafting percentage of 1.49%

Acid-modified polypropylene (F-3):

Maleic anhydride-modified polypropylene, ADMER QF551, manufactured by Mitsui Chemicals, Inc., a grafting percentage of 0.08%

Acid-modified polypropylene (F-4):

Maleic anhydride-modified polypropylene, TOYO-TAC PMA-H1000P, manufactured by Toyobo Co., Ltd., a grafting percentage of 1.01%

Acid-modified polypropylene (F-5):

Maleic anhydride-modified polypropylene, SCONA TPPP 2003 GB, manufactured by BYK Japan KK, a grafting percentage of 0.28%

Note that, the grafting percentage in the acid-modified elastomer or the acid-modified polypropylene was obtained from a spectrum obtained by ¹H-NMR measurement after methyl-esterifying the graft maleic anhydride moiety.

### Example 1

First, 10 parts by mass of fibrous basic magnesium sulfate (A-1), 65 parts by mass of a propylene polymer (B), 25 parts by mass of a polyolefin elastomer (C), 0.3 parts by mass of a fatty acid metal salt (E), and 1 part by mass of an acid-modified elastomer (F-1) were mixed. The obtained mixture was melt-kneaded using a twin-screw extruding kneader (Labo Plastomill manufactured by Toyo Seiki Seisaku-sho, Ltd.) to obtain a resin composition of Example 1.

### Example 2

A resin composition of Example 2 was obtained in the same manner as in Example 1 except that the amount of the acid-modified elastomer (F-1) was changed to 3 parts by mass.

### Example 3

A resin composition of Example 3 was obtained in the same manner as in Example 1 except that the acid-modified elastomer (F-1) was changed to the same amount of (F-2).

### Example 4

A resin composition of Example 4 was obtained in the same manner as in Example 3 except that the amount of the acid-modified elastomer (F-2) was changed to 3 parts by mass.

### Comparative Example 1

A resin composition of Comparative Example 1 was obtained in the same manner as in Example 1 except that no acid-modified elastomer (F-1) was blended.

### Comparative Example 2

A resin composition of Comparative Example 2 was obtained in the same manner as in Example 1 except that the amount of the acid-modified elastomer (F-1) was changed to 5 parts by mass.

### Comparative Example 3

A resin composition of Comparative Example 3 was obtained in the same manner as in Example 3 except that the amount of the acid-modified elastomer (F-2) was changed to 5 parts by mass.

### Comparative Example 4

A resin composition of Comparative Example 4 was obtained in the same manner as in Example 1 except that the acid-modified elastomer (F-1) was changed to the same amount of acid-modified polypropylene (F-3).

### Comparative Example 5

A resin composition of Comparative Example 5 was obtained in the same manner as in Example 2 except that the acid-modified elastomer (F-1) was changed to the same amount of acid-modified polypropylene (F-3).

### Comparative Example 6

A resin composition of Comparative Example 6 was obtained in the same manner as in Comparative Example 2 except that the acid-modified elastomer (F-1) was changed to the same amount of acid-modified polypropylene (F-3).

### Comparative Examples 7 to 9

Resin compositions of Comparative Examples 7 to 9 were obtained in the same manner as in Comparative Examples 4 to 6 respectively, except that acid-modified polypropylene (F-3) was changed to the same amount of acid-modified polypropylene (F-4).

### Comparative Examples 10 to 12

Resin compositions of Comparative Examples 10 to 12 were obtained in the same manner as in Comparative Examples 4 to 6 respectively, except that acid-modified polypropylene (F-3) was changed to the same amount of acid-modified polypropylene (F-5).

The following Table 1 summarizes formulations of resin compositions of Examples and Comparative Examples.

TABLE 1

| | A | | | | F | | | | |
|---|---|---|---|---|---|---|---|---|---|
| | A-1 | B | C | E | F-1 | F-2 | F-3 | F-4 | F-5 |
| Example 1 | 10 | 65 | 25 | 0.3 | 1 | | | | |
| Example 2 | 10 | 65 | 25 | 0.3 | 3 | | | | |
| Example 3 | 10 | 65 | 25 | 0.3 | | 1 | | | |
| Example 4 | 10 | 65 | 25 | 0.3 | | 3 | | | |
| Comparative Example 1 | 10 | 65 | 25 | 0.3 | | | | | |
| Comparative Example 2 | 10 | 65 | 25 | 0.3 | 5 | | | | |
| Comparative Example 3 | 10 | 65 | 25 | 0.3 | | 5 | | | |
| Comparative Example 4 | 10 | 65 | 25 | 0.3 | | | 1 | | |
| Comparative Example 5 | 10 | 65 | 25 | 0.3 | | | 3 | | |
| Comparative Example 6 | 10 | 65 | 25 | 0.3 | | | 5 | | |
| Comparative Example 7 | 10 | 65 | 25 | 0.3 | | | | 1 | |
| Comparative Example 8 | 10 | 65 | 25 | 0.3 | | | | 3 | |
| Comparative Example 9 | 10 | 65 | 25 | 0.3 | | | | 5 | |
| Comparative Example 10 | 10 | 65 | 25 | 0.3 | | | | | 1 |
| Comparative Example 11 | 10 | 65 | 25 | 0.3 | | | | | 3 |
| Comparative Example 12 | 10 | 65 | 25 | 0.3 | | | | | 5 |

<Preparation of Test Piece>

Each resin composition was molded into a molded body having a predetermined size using an electric injection molding machine (C,Mobile manufactured by Shinko Celvic Co., Ltd.) to obtain a strip-shaped test piece (length: 80 mm, width: 10 mm, thickness: 4 mm) for evaluation of mechanical characteristics and a flat-plate-shaped test piece (length: 40 mm, width: 40 mm, thickness: 1 mm) for blister evaluation.

<Preparation of Test Piece for Blister Evaluation>

A primer (Pitaking 602ECO manufactured by Solar Co., Ltd.), a base coat (Admila α manufactured by Nippon Paint Co., Ltd.), and a clear coat (Hi·po clear manufactured by Nippon Paint Co., Ltd.) were sequentially applied to one surface of the flat-plate-shaped test piece to prepare a test piece for blister evaluation.

<Blister Evaluation>

The test piece for blister evaluation was immersed in ion-exchanged water at 80° C. and allowed to stand for 48 hours. After the immersion, the test piece was dried, and the blister generation state on the surface was observed with an optical microscope. From the presence or absence of a blister having a diameter of 0.1 mm or more in the observation area of 4 cm², the blister generation state was evaluated as follows.

No blister generated: ∘

A blister generated: ×

<Evaluation of Mechanical Characteristics>

The flexural modulus and the Charpy impact strength were measured by the following procedure using the strip-shaped test piece for evaluation of mechanical characteristics.

<Evaluation of Flexural Modulus>

A three-point bending test was performed by a method in accordance with JIS K7171 using a universal mechanical tester (AGS-x manufactured by Shimadzu Corporation). The flexural modulus was evaluated from an obtained load-deflection curve. The measurement temperature was 23° C.

<Charpy Impact Strength>

The notched impact strength was evaluated by a method in accordance with JIS K7111 using a Charpy impact tester (manufactured by MYS-TESTER Company Limited). The measurement temperature was 23° C.

In the following Table 2, the evaluation results of the molded bodies employing the respective resin compositions are summarized together with the blister suppressing effect.

TABLE 2

| | Blister | Flexural | Charpy impact |
|---|---|---|---|
| | suppressing | modulus | strength |
| | effect | (GPa) | (kJ/m²) |
| Example 1 | ∘ | 2.0 | 58 |
| Example 2 | ∘ | 1.6 | 58 |
| Example 3 | ∘ | 1.8 | 56 |
| Example 4 | ∘ | 1.5 | 60 |
| Comparative Example 1 | x | 2.0 | 54 |
| Comparative Example 2 | ∘ | 1.1 | 62 |
| Comparative Example 3 | ∘ | 1.1 | 58 |
| Comparative Example 4 | x | 2.0 | 58 |
| Comparative Example 5 | x | 2.0 | 55 |
| Comparative Example 6 | x | 1.8 | 53 |
| Comparative Example 7 | x | 1.6 | 52 |
| Comparative Example 8 | ∘ | 1.9 | 18 |
| Comparative Example 9 | ∘ | 1.8 | 18 |
| Comparative Example 10 | x | 1.9 | 58 |
| Comparative Example 11 | x | 2.0 | 42 |
| Comparative Example 12 | ∘ | 1.8 | 45 |

As shown in Table 2 above, in molded bodies that employ respective resin compositions of Examples 1 to 4 each containing a predetermined amount of maleic anhydride-modified SEBS, generation of blisters is suppressed, the flexural modulus is 1.5 GPa or more, and the Charpy impact strength is 56 kJ/m² or more. That is, in the molded bodies of Examples, both suppression of blisters and high mechanical strength are achieved.

On the other hand, when the maleic anhydride-modified SEBS is not contained (Comparative Example 1), blisters cannot be suppressed. When the amount of the maleic anhydride-modified SEBS is 0.5 times the amount of the basic magnesium sulfate (Comparative Examples 2 and 3), the flexural modulus is only 1.1 GPa, and the mechanical properties are poor. When the maleic anhydride-modified polypropylene is blended instead of the maleic anhydride-modified SEBS (Comparative Examples 4 to 12), both suppression of blisters and high mechanical properties cannot be achieved.

1. A polypropylene resin composition comprising:
1 to 41 parts by mass of fibrous basic magnesium sulfate;
50 to 98 parts by mass of a propylene polymer;
0.02 to 1.6 parts by mass of a lubricant; and
less than 0.5 times an amount of the fibrous basic magnesium sulfate and 0.1 to 20 parts by mass of an acid-modified elastomer.

2. The polypropylene resin composition according to claim 1, further comprising up to 40 parts by mass of an elastomer.

3. The polypropylene resin composition according to claim 1, further comprising up to 40 parts by mass of a non-fibrous filler.

4. The polypropylene resin composition according to claim 1, wherein the acid-modified elastomer is a maleic anhydride-modified elastomer.

5. A method for producing a polypropylene resin composition, the method comprising mixing 1 to 41 parts by mass of basic magnesium sulfate that is fibrous, 50 to 98 parts by mass of a propylene polymer, 0.02 to 1.6 parts by mass of a lubricant, and less than 0.5 times an amount of the basic magnesium sulfate and 0.1 to 20 parts by mass of an acid-modified elastomer to form a mixture, and then melt-kneading the mixture.

6. A molded body that is a molded product of the polypropylene resin composition according to claim 1.
